(19) United States
(12) Patent Application Publication
(10) Pub. No.: US 2006/0174060 A1
(43) Pub. Date: Aug. 3, 2006

(54) Information processing apparatus and method for controlling disk device

(75) Inventor: Kenichi Saito, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/331,038

(22) Filed: Jan. 13, 2006

(30) Foreign Application Priority Data
Jan. 14, 2005 (JP) 2005-007923

(51) Int. Cl. G06F 12/14

(52) U.S. Cl. 711/114

(57) ABSTRACT

An information processing apparatus includes: a main body; a first disk device that is built into the main body; an attachment portion to which a device is detachably attached, the attachment portion being disposed in the main body; a disk controller that controls the first disk device and a second disk device, the second disk device being attachable to the attachment portion; and a disc controller that controls a third disc device, the third disc device being attachable to the attachment portion.

### RELATED APPLICATIONS

The present disclosure relates to the subject matter contained in Japanese Patent Application No. 2005-007923 filed on Jan. 14, 2005, which is incorporated herein by reference in its entirety.

### FIELD

The present invention relates to an information processing apparatus having an attachment portion to which a device is detachably attached, and particularly to an information processing apparatus capable of properly controlling a built-in disk device and a disk device attached to the attachment portion and a disk device control method implemented in the apparatus.

### BACKGROUND

Development of an information processing apparatus including a select bay slot has proceeded in recent years. The select bay slot is a slot to which a group of disk devices such as an HDD (Hard Disk Drive) or an ODD (Optical Disc Drive) can be attached selectively. The information processing apparatus needs to properly control a disk device previously built into the information processing apparatus or a disk device attached to the select bay slot.

As a control method of disk devices which the information processing apparatus has, for example, it is contemplated to be designed so as to configure an array system using plural HDDs in order to configure a disk array system called RAID (Redundant Array of Independent Disks).

In JP-A-2001-523860, a function of connecting plural HDDs to an array controller and implementing an array system is disclosed.

As disclosed in JP-A-2001-523860, one method for controlling plural HDDs includes a control method for configuring an array system using plural HDDs.

### SUMMARY

However, in an information processing apparatus including a select bay slot, an ODD as well as an HDD can be attached to the select bay slot, so that it is necessary to control disk devices in consideration of a built-in disk device and types of disk devices attached to the select bay slot.

The present invention provides an information processing apparatus capable of properly controlling a built-in disk device and a disk device attached to an attachment portion, and a disk device control method implemented in the same apparatus.

### BRIEF DESCRIPTION OF THE DRAWINGS

In the accompanying drawings:

FIG. 1 is a perspective view showing one example of a state in which a display unit is opened to a body;

FIG. 2 is a block diagram describing one example of a configuration of a computer;

FIG. 3 is a block diagram describing one example of a group of ATA controllers built into an I/O hub;

FIG. 4 is a block diagram describing one example of a group of devices in which information necessary to configure a RAID array system is stored;

FIG. 5 is a diagram showing one example of a format of RAID information; and

FIG. 6 is a flowchart describing one example of a procedure for configuring a RAID array system configured by an HDD and an HDD attached to a select bay slot.

### DETAILED DESCRIPTION OF THE EMBODIMENT

Hereinafter, embodiments of the invention will be described by reference to the drawings in detail.

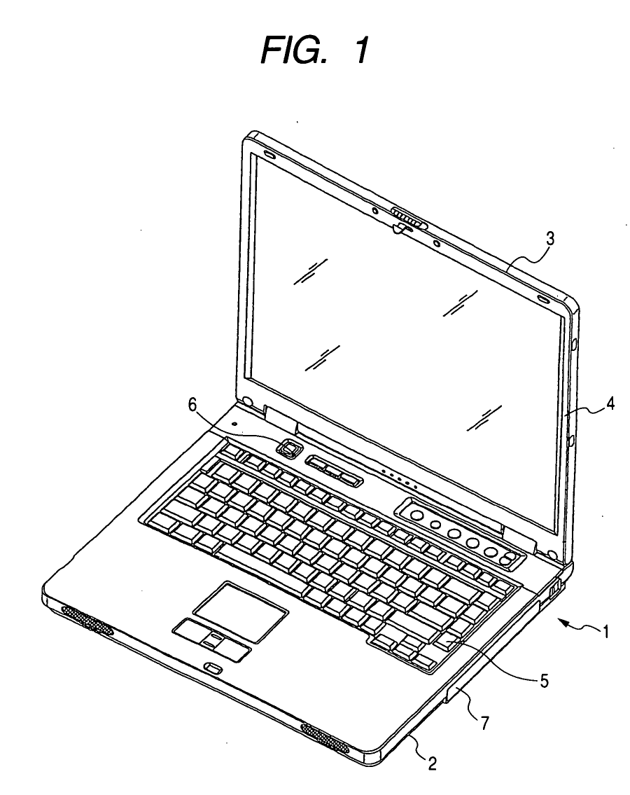

FIG. 1 is a view showing one example of a state in which a display unit 3 of a notebook personal computer (hereinafter called a computer) 1 is opened with respect to a body 2.

The computer 1 includes the body 2 and the display unit 3. A display having an LCD (Liquid Crystal Display) 4 is incorporated into the display unit 3 and the LCD 4 is located in approximately the center of the display unit 3.

The display unit 3 is rotatably mounted between an opened position and a closed position with respect to the body 2. The body 2 has an approximately box shape, and a keyboard unit 5, a power button 6 for turning on and off a power source of the computer 1, etc. are arranged on an upper surface of the body 2. The power button 6 is pressed and operated to start using the computer 1.

The body 2 is provided with a select bay slot (attachment portion) 7 at a side portion thereof. A group of devices corresponding to the select bay slot 7 can be detachably attached to the select bay slot 7. The group of devices corresponding to the select bay slot 7 include devices of types of an ODD (Optical Disc Drive), an HDD (Hard Disk Drive), a TV tuner, etc. Next, a configuration of the computer 1 will be described.

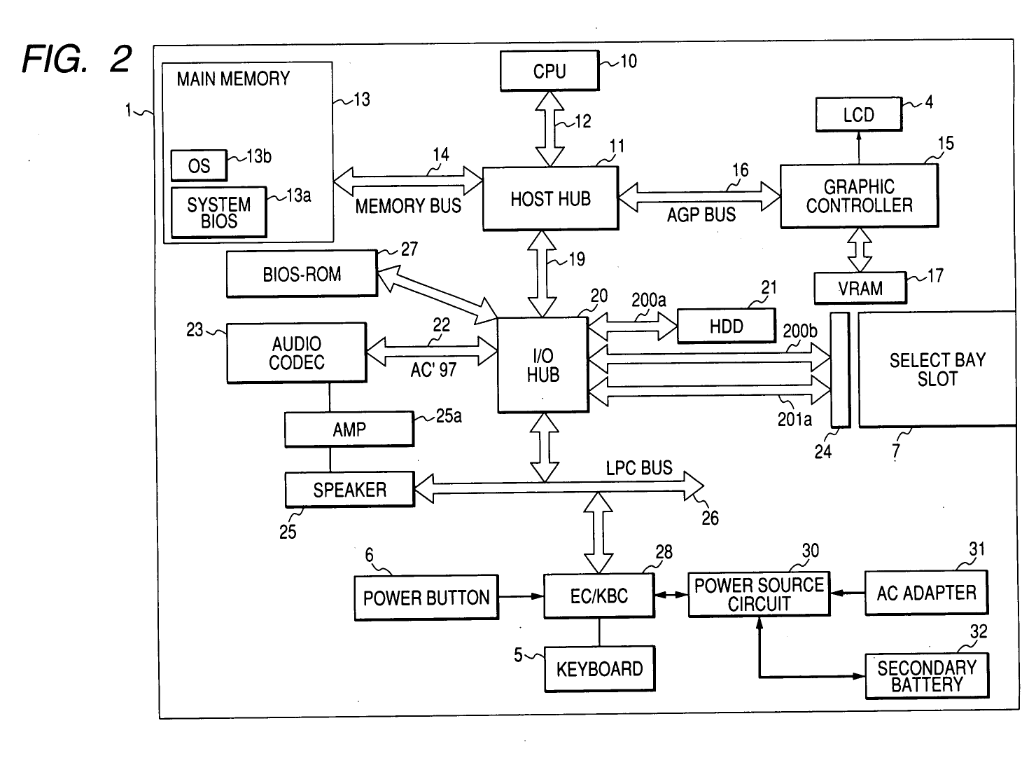

FIG. 2 is a block diagram describing one example of a configuration of the computer 1.

A CPU 10, main memory 13, a graphics controller 15 and an I/O (Input/Output) hub 20 are connected to a host hub (first bridge circuit) 11.

The host hub 11 is connected to the CPU 10 through a system bus 12. A memory controller for controlling access to the main memory 13 is built into the host hub 11.

The CPU 10 is a main processor for controlling an action of the computer 1. The CPU 10 executes an operating system (OS) 13b, an application program and a utility program loaded from an HDD 21 which is an external storage device to the main memory 13 through a memory bus 14.

Also, the CPU 10 executes a System BIOS (Basic Input Output System) 13a loaded from BIOS-ROM 27 to the main memory 13.

The graphics controller 15 connected to the host hub 11 through an AGP (Accelerated Graphics Port) bus 16 outputs a digital display signal to the LCD 4. Video memory (VRAM) 17 is connected to the graphics controller 15, and the graphics controller 15 displays data drawn in the video memory 17 by an OS/application program on the LCD 4.

The I/O hub (second bridge circuit) 20 connected to the host hub 11 through a dedicated bus such as a hub interface controls each of the devices on an LPC (low pin count) bus 26.

The I/O hub 20 is connected to the HDD 21 which is an external storage device and supports serial ATA standards through a first serial ATA bus 200a for supporting serial ATA standards. Description will be made below in detail, and the I/O hub 20 is connected to an expansion connector 24 through a second serial ATA bus 200b and a parallel ATA bus 201a for supporting parallel ATA standards.

The expansion connector 24 is connected to each of the connectors disposed in a group of devices capable of being attached to the select bay slot 7.

The HDD 21 is a magnetic disk device previously built into the computer 1. An operating system (OS), an application program, a utility program, and data etc. generated by using the application program are stored in the HDD 21.

An audio codec 23 is connected to the I/O hub 20 through an AC (Audio Codec) 97 (22). The audio codec 23 is a kind of codec for input and output of sound. The audio codec 23 has a codec part etc. of sound inputted and outputted.

An amplifier 25a is connected to the audio codec 23. The amplifier 25a amplifies a sound signal generated by the audio codec 23. The sound signal amplified by the amplifier 25a is sent out to a speaker and the speaker outputs sound waves of an audio frequency band.

An embedded controller/keyboard controller IC (EC/KBC) 28 is connected on the LPC bus 26.

The embedded controller/keyboard controller IC (EC/KBC) 28 is a one-chip microcomputer into which an embedded controller for performing power management etc. and a keyboard controller for controlling the keyboard (KB) unit 5 are integrated.

The keyboard 5, the power button 6 and a power source circuit 30 are connected to the EC/KBC 28. Further, an AC adapter 31 and a secondary battery 32 are connected to the power source circuit 30.

The power source circuit 30 supplies electric power supplied from the AC adapter 31 or the secondary battery 32 to each of the modules inside the computer 1. The secondary battery 32 is replaceably disposed. When a power source is supplied from the AC adapter 31 to the computer 1, electric power supplied from the AC adapter 31 is accumulated in the secondary battery 32 through the power source circuit 30.

When a user operates the power button 6, the EC/KBC 28 detects that the power button 6 is operated. When the EC/KBC 28 detects that the power button 6 is operated, control is performed so as to start power source supply from the AC adapter 31 or the secondary battery 32 to a system of the computer 1 by controlling the power source circuit 30. Next, a group of ATA controllers built into the I/O hub 20 will be described.

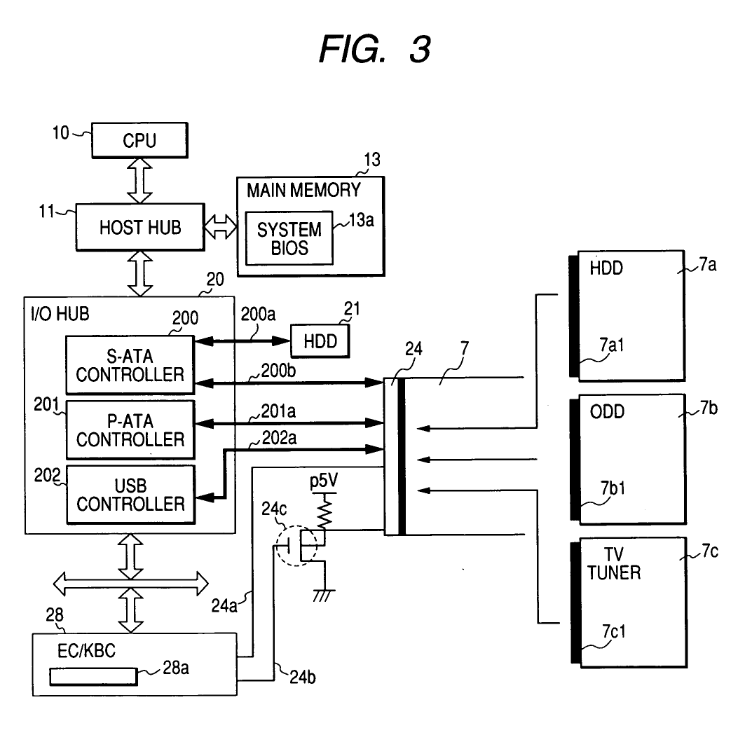

FIG. 3 is a block diagram describing one example of a group of disk controllers built into the I/O hub 20.

A serial ATA (S-ATA) controller (first disk controller) 200 for controlling the first serial ATA bus 200a and the second serial ATA bus 200b, a parallel ATA (P-ATA) controller (second disc controller) 201 for controlling the parallel ATA bus 201a, and a USB controller 202 for controlling a USB bus 202a are built into the I/O hub 20.

The S-ATA controller 200 is connected to the HDD 21 built into the computer 1 through the first serial ATA bus 200a.

In a state of enabling the HDD 21 built into the computer 1, the S-ATA controller 200 and the first serial. ATA bus 200a are in an enabled state.

The EC/KBC 28 has a register 28a for storing types of devices attached to the select bay slot 7.

When a HDD 7a corresponding to the select bay slot 7 is attached to the select bay slot 7, the expansion connector 24 is connected to a connector 7a1 disposed in the HDD 7a corresponding to the select bay slot 7. When the expansion connector 24 is connected to the connector 7a1, the EC/KBC 28 detects that a device attached to the select bay slot 7 is the HDD 7a by reading a voltage value of a signal line 24a.

Similarly, when an ODD 7b corresponding to the select bay slot 7 is attached to the select bay slot 7, the expansion connector 24 is connected to a connector 7b1 disposed in the ODD 7b corresponding to the select bay slot 7. When the expansion connector 24 is connected to the connector 7b1, the EC/KBC 28 detects that a device attached to the select bay slot 7 is the ODD 7b by reading a voltage value of the signal line 24a.

After the EC/KBC 28 recognizes the device attached to the select bay slot 7, a signal for controlling a switch 24c from OFF to ON is sent out through a signal line 24b. Then, power source supply to the device attached to the select bay slot 7 is started.

After the EC/KBC 28 recognizes the device attached to the select bay slot 7, a type of the device recognized is written into the register 28a.

When the HDD 7a is attached to the select bay slot 7 and the EC/KBC 28 writes the fact that a type of the device recognized is the HDD 7a into the register 28a, the EC/KBC 28 sends out an SMI (System Management Interrupt) signal to the I/O hub 20.

The System BIOS 13a executed by the CPU 10 performs SMI processing and thereby, the System BIOS 13a enables the second serial ATA bus 200b disposed inside the I/O hub 20. Thereafter, the System BIOS 13a initializes the HDD 7a. After initializing the HDD 7a, the S-ATA controller 200 can control the HDD 7a.

On the other hand, when the ODD 7b is attached to the select bay slot 7 and the EC/KBC 28 writes the fact that a type of the device recognized is the ODD 7b into the register 28a, the EC/KBC 28 sends out an SMI (System Management Interrupt) signal to the I/O hub 20.

The System BIOS 13a executed by the CPU 10 performs SMI processing and thereby, the System BIOS 13a enables the parallel ATA bus 201a and the P-ATA controller 201 disposed inside the I/O hub 20. Thereafter, the System BIOS 13a initializes the ODD 7b. After initializing the ODD 7b, the P-ATA controller 201 can control the ODD 7b.

In a manner similar to the case of the HDD 7a and the ODD 7b described above, when a TV tuner 7c corresponding to the select bay slot 7 is attached to the select bay slot 7, power source supply to the TV tuner 7c is started and then, the USB controller 202 and the USB bus 202a are enabled and further, the TV tuner 7c is initialized.

The HDD 21 and the HDD 7a attached to the select bay slot 7 are controlled by the S-ATA controller 200 and the ODD 7b attached to the select bay slot 7 is controlled by the P-ATA controller 201 and thereby, the respective disk devices can be controlled properly using the respective controllers according to types of the disk devices.

Next, a method for configuring a RAID array system configured by the HDD 21 and the HDD 7a attached to the select bay slot 7 will be described. First, information stored in the HDD 21 and the HDD 7a configuring the RAID array system and a RAID driver necessary to configure the RAID array system by the HDD 21 and the HDD 7a will be described.

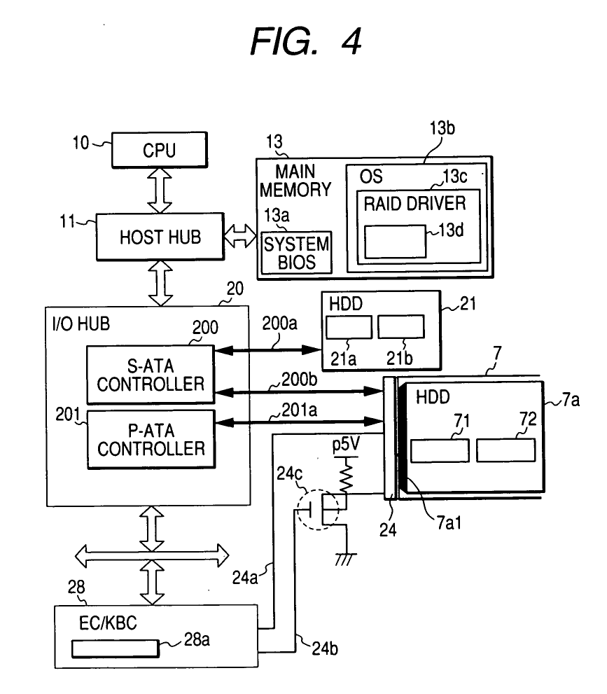

FIG. 4 is a block diagram describing one example of a group of devices in which information necessary to configure the RAID array system is stored.

Information (disk information) about specifications of an HDD 7a (for example, a model, a disk capacity of the HDD 7a) is stored in a first area 71 inside the HDD 7a attached to a select bay slot 7. Similarly, information (disk information) about specifications of an HDD 21 (for example, a model, a disk capacity of the HDD 21) is stored in a first area 21a inside the HDD 21.

Also, RAID information for defining a RAID array configuration is stored in a second area 72 inside the HDD 7a attached to the select bay slot 7. Similarly, RAID information for defining a RAID array configuration is stored in a second area 21b inside the HDD 21.

An OS 13b stored in main memory 13 has a RAID driver 13c. The RAID driver 13c controls whether each of the HDD 21 and the HDD 7a attached to the select bay slot 7 is used as the HDD which configures the RAID array system or is used as the HDD which does not configure the RAID array system.

The RAID driver 13c has a RAID information area 13d for storing the RAID information stored in the respective second areas of the HDD 21 and the HDD 7a attached to the select bay slot 7.

In the embodiment, the CPU 10, the host hub 11, the main memory 13, a RAID driver 13c, and a RAID information area 13d serve as a control unit that controls the first magnetic disk device and the second magnetic disk device to serve as an disk array system, when the attachment of the second magnetic disk device is detected by the detection unit. Next, a format of the RAID information will be described.

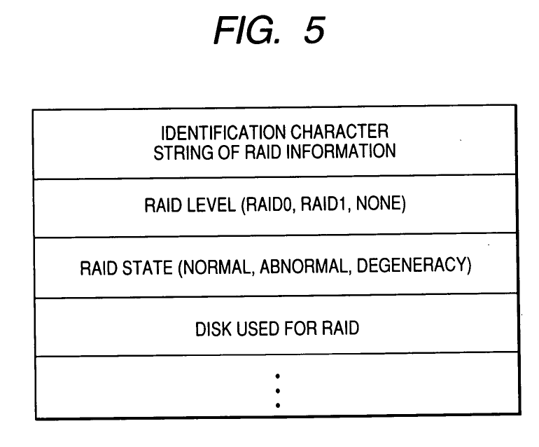

FIG. 5 is a diagram showing one example of a format of the RAID information. The RAID information includes a specific character string (RAID information identification character string) used as an identifier for identifying the information as RAID information. The RAID information includes information (RAID level information) indicating a RAID level of the RAID array system configured by a group of HDDs (HDD 21 and HDD 7a) including the HDD in which the information is stored.

Further, the RAID information includes RAID state information and RAID configuration disk information. The RAID state information indicates a state of the RAID array system, for example, it is a normal state, an abnormal state or a degeneracy operating state operated in only some HDD. The RAID configuration disk information indicates an HDD configuring the RAID array system. Next, a method for configuring the RAID array system configured by the HDD 21 and the HDD 7a attached to the select bay slot 7 will be described.

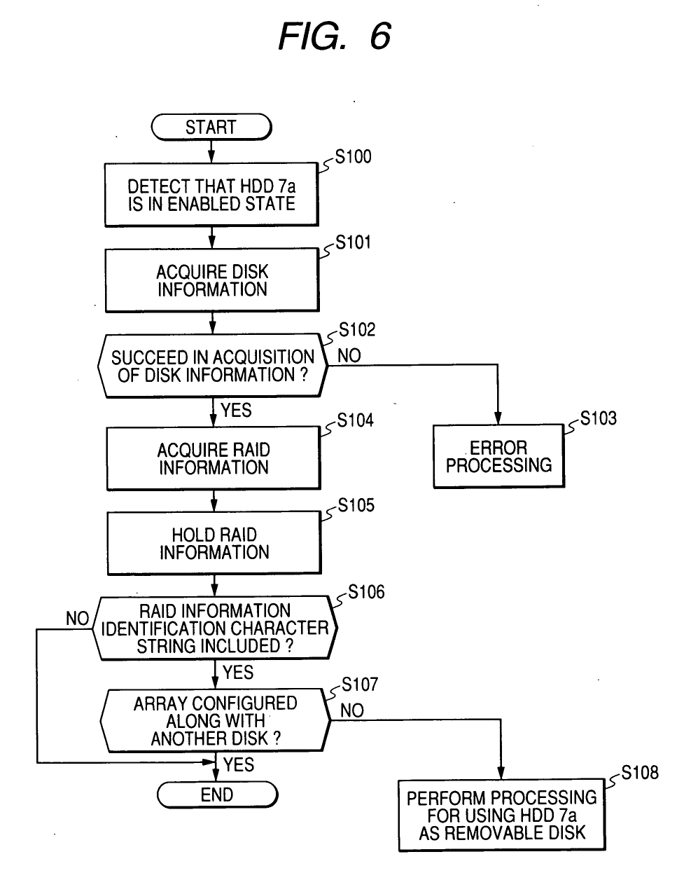

FIG. 6 is a flowchart describing one example of a procedure for configuring the RAID array system configured by the HDD 21 and the HDD 7a attached to the select bay slot 7.

When the RAID driver 13c detects that the HDD 7a attached to the select bay slot 7 is in an enabled state (step S100), the RAID driver 13c acquires disk information about the HDD 7a stored in the first area 71 inside the HDD 7a (step S101).

When the RAID driver 13c fails in acquisition of the disk information about the HDD 7a, that is, cannot read the disk information about the HDD 7a correctly (step S102 No), predetermined error processing is performed (step S103).

On the other hand, when the RAID driver 13c succeeds in acquisition of the disk information about the HDD 7a, that is, can read the disk information about the HDD 7a correctly (step S102 Yes), the RAID driver 13c acquires RAID information stored in the second area 72 inside the HDD 7a (step S104), and holds RAID information acquired in the RAID information area 13d (step S105).

The RAID driver 13c determines whether or not the RAID information is stored in the HDD 7a by determining whether or not RAID information identification character string is included in the RAID information held in the RAID information area 13d (step S106).

When the RAID information identification character string is included in the RAID information held in the RAID information area 13d, that is, the RAID information is stored in the HDD 7a (step S106 Yes), the RAID driver 13c determines whether or not the RAID array system is configured by the HDD 7a along with the HDD 21 (step S107)

The determination made in step S107 is made using RAID information held in a predetermined position of the RAID information area 13d (more specifically, RAID configuration disk information included in RAID information). That is, the RAID driver 13c determines whether or not the HDD configuring the RAID array system is present other than the HDD 7a by referring to the RAID configuration disk information.

When the RAID driver 13c determines that the HDD configuring the RAID array system is the HDD 21 along with the HDD 7a by referring to the RAID configuration disk information indicating the HDD 21 (step S107 Yes), the RAID driver 13c decides that a logical disk is not increased newly by attaching an HDD 22, and ends the processing. In this case, the HDD 21 is used as the HDD configuring the RAID array system along with the HDD 7a.

On the other hand, when the RAID driver 13c determines that the RAID array system is not configured by the HDD 21 along with the HDD 7a by referring to the RAID configuration disk information, that is, the HDD 21 is not indicated in the RAID configuration disk information (step S107 No), the RAID driver 13c performs processing for enabling the HDD 7a as a removable disk.

The HDD 7a attached to the select bay slot 7 is connected to the S-ATA controller 200 to which the built-in HDD 21 is connected and thereby, the RAID array system can be configured using the built-in HDD 21 and the HDD 7a attached to the select bay slot 7.

As described above with reference to the embodiment, there is provided an information processing apparatus capable of properly controlling a built-in disk device and a disk device attached to an attachment portion, and a disk device control method implemented in the same apparatus can be provided.

The present invention is not limited to the as-is embodiment described above and when implemented into an actual product, components can be modified and embodied without departing from the scope of the inbetnion. Also, various embodiments can be obtained by proper combinations of plural components disclosed in the above-described embodiment. For example, some components may be deleted from all the components shown in the embodiment. Further, components in the different embodiment may be combined properly.

The foregoing description of the embodiment of the invention has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. An information processing apparatus comprising:
a main body;
a first disk device that is built into the main body;
an attachment portion to which a device is detachably attached, the attachment portion being disposed in the main body;
a disk controller that controls the first disk device and a second disk device, the second disk device being attachable to the attachment portion; and
a disc controller that controls a third disc device, the third disc device being attachable to the attachment portion.

2. The information processing apparatus according to claim 1, wherein the first disk device includes a first magnetic disk device and the second disk device includes a second magnetic disk device, and
wherein the information processing apparatus further comprises:
a detection unit that detects the attachment of the second magnetic disk device to the attachment portion; and
a control unit that controls the first magnetic disk device and the second magnetic disk device to serve as an disk array system, when the attachment of the second magnetic disk device is detected by the detection unit.

3. The information processing apparatus according to claim 1, further comprising:
a bus that is provides communication between the disk controller and the second disk device attached to the attachment portion; and
a bus controller that enables the bus to provide communication when the second disk device is attached to the attachment portion.

4. The information processing apparatus according to claim 2, wherein the disk controller is a serial ATA controller and the disc controller is a parallel ATA controller.

5. The information processing apparatus according to claim 1, wherein the disk controller and the disc controller are built into a single semiconductor chip.

6. A method for controlling a disk device used in an information processing apparatus having an attachment portion to which a device is detachably attached, the method comprising:
controlling a second disk device that is attached to the attachment portion using a disk controller for controlling the first disk device built into the information processing apparatus; and
controlling a third disc device that is attached to the attachment portion using a disc controller that is different from the first disk controller.

7. The method according to claim 6, wherein the first disk device includes a first magnetic disk device and the second disk device includes a second magnetic disk device, and
wherein the method further comprises configuring a disk array system using the first magnetic disk device and the second magnetic disk device attached to the detachable part.

8. An information processing apparatus comprising:
a main body;
a first magnetic disk device that is built into the main body;
an attachment portion to which a device is detachably attached, the attachment portion being disposed in the main body;
a disk controller that controls the first magnetic disk device and a second magnetic disk device that is attachable to the attachment portion;
a detection unit that detects the attachment of the second magnetic disk device to the attachment portion; and
a control unit that controls the first magnetic disk device and the second magnetic disk device to serve as an disk array system, when the attachment of the second magnetic disk device is detected by the detection unit.

9. The information processing apparatus according to claim 8, further comprising:
a bus that is provides communication between the disk controller and the second magnetic disk device attached to the attachment portion; and
a bus controller that enables the bus to provide communication when the second magnetic disk device is attached to the attachment portion.
